(19) United States
(12) Patent Application Publication
(10) Pub. No.: US 2025/0110755 A1
(43) Pub. Date: Apr. 3, 2025

(54) METHOD, DEVICE, AND COMPUTER PROGRAM PRODUCT FOR PROVIDING INTERFACE

(71) Applicant: DELL PRODUCTS L.P., ROUND ROCK, TX (US)

(72) Inventors: Yuefeng Li, Shanghai (CN); Ren Wang, Shanghai (CN); Yun Zhang, Shanghai (CN); Weiyang Liu, Shanghai (CN); Qi Wang, Shanghai (CN)

(21) Appl. No.: 18/505,365

(22) Filed: Nov. 9, 2023

(30) Foreign Application Priority Data
Sep. 28, 2023 (CN) 202311276897.6

(51) Int. Cl. G06F 9/451; G06F 9/54

(52) U.S. Cl. CPC G06F 9/451; G06F 9/543

(57) ABSTRACT

A method for providing an interface includes acquiring a general interface specification associated with a back-end interface. The method further includes generating, based on the general interface specification and a first mapping, a first front-end interface specification. The method further includes converting, based on the first front-end interface specification, a first front-end request into a first back-end request associated with the back-end interface. The method further includes generating, based on the general interface specification and a second mapping, a second front-end interface specification, the second mapping indicating a relationship between the general interface specification and the second front-end interface specification. Furthermore, the method further includes converting, based on the second front-end interface specification, a second front-end request into a second back-end request associated with the back-end interface. In this way, the workload for interface development can be minimized, and interface maintenance is simplified, thereby reducing labor and time costs.

### TECHNICAL FIELD

The present disclosure relates to the field of computer application development, and more particularly, to a method, a device, and a computer program product for providing an interface.

### BACKGROUND

Application Programming Interface (API) is a set of tools that implement communication and interaction between different software components and enables different applications to share data and functions so that they can work together effectively. APIs may be regarded of as a bridge between multiple applications, which defines how to request or send data, perform operations, and acquire required responses.

API specifications are a collection of rules about how to design, construct, and use APIs. These specifications are intended to ensure that APIs can communicate and interact efficiently between different applications, while providing a standardized way to access and use functions of the APIs. An API specification may typically include endpoints and paths of an API, methods (e.g., GET, POST, PUT, and DELETE) to be used during interaction with the API endpoints, data formats of API requests and responses, types and formats of parameters, and the like. When multiple clients have different requirements for the same application, the problem to be solved is how to efficiently provide a corresponding API interface for each client.

### SUMMARY OF THE INVENTION

Embodiments of the present disclosure provide a method, a device, and a computer program product for providing an interface. In a solution provided by the embodiments of the present disclosure, a pre-determined general interface specification may be acquired, and the general interface specification is associated with an API actually provided by the back end. Then, in this solution, a mapping description document for a first client may be acquired, the mapping description document describing a conversion relationship between the general interface specification and a first front-end interface specification for the first client. Then, in this solution, the first front-end interface specification may be generated based on the mapping description document for the first client and the general interface specification. In this solution, upon receiving a request from the first client that conforms to the first front-end interface specification, the request may be converted, based on the first front-end interface specification, into a back-end request that conforms to a back-end interface and may be processed by a back-end server. In addition, in this solution, a mapping description document for a second client may be acquired, the mapping description document describing a conversion relationship between the general interface specification and a second front-end interface specification for the second client. Then, in this solution, the second front-end interface specification may be generated based on the mapping description document for the second client and the general interface specification. In this solution, upon receiving a request from the second client that conforms to the second front-end interface specification, the request may be converted, based on the second front-end interface specification, into a back-end request that conforms to the same back-end interface and may be processed by the back-end server. In this way, an interface developer does not need to develop two groups of interfaces for the first client and the second client having different requirements, but only needs to provide mapping description documents that satisfy specific requirements, so that different front-end interface specifications corresponding to various types of clients may be automatically generated, thus providing different front-end interfaces for clients having different requirements based on the same back-end interface. In this way, the workload for interface development can be minimized, the general interface specification and the mapping description documents can also be reused easily, and interface maintenance is simplified, thereby reducing labor and time costs.

In a first aspect of the present disclosure, a method for providing an interface is provided. The method includes acquiring a general interface specification associated with a back-end interface. The method further includes generating, based on the general interface specification and a first mapping, a first front-end interface specification, the first mapping indicating a conversion relationship between the general interface specification and the first front-end interface specification. The method further includes converting, based on the first front-end interface specification, a first front-end request into a first back-end request associated with the back-end interface. The method further includes generating, based on the general interface specification and a second mapping, a second front-end interface specification, the second mapping indicating a relationship between the general interface specification and the second front-end interface specification, and the first front-end interface specification being different from the second front-end interface specification; Furthermore, the method further includes converting, based on the second front-end interface specification, a second front-end request into a second back-end request associated with the back-end interface.

In a second aspect of the present disclosure, an electronic device is provided. The electronic device includes one or more processors; and a memory coupled to the at least one processor and having instructions stored thereon. The instructions, when executed by the at least one processor, cause the electronic device to perform actions including acquiring a general interface specification associated with a back-end interface. The actions further include generating, based on the general interface specification and a first mapping, a first front-end interface specification, the first mapping indicating a conversion relationship between the general interface specification and the first front-end interface specification. The actions further include converting, based on the first front-end interface specification, a first front-end request into a first back-end request associated with the back-end interface. The actions further include generating, based on the general interface specification and a second mapping, a second front-end interface specification, the second mapping indicating a relationship between the general interface specification and the second front-end interface specification, and the first front-end interface specification being different from the second front-end interface specification; Furthermore, the actions further include converting, based on the second front-end interface specification, a second front-end request into a second back-end request associated with the back-end interface.

In a third aspect of the present disclosure, a computer-readable storage medium is provided. A computer program is stored thereon. When executed by a processor, the program implements a method for providing an interface. The method includes acquiring a general interface specification associated with a back-end interface. The method further includes generating, based on the general interface specification and a first mapping, a first front-end interface specification, the first mapping indicating a conversion relationship between the general interface specification and the first front-end interface specification. The method further includes converting, based on the first front-end interface specification, a first front-end request into a first back-end request associated with the back-end interface. The method further includes generating, based on the general interface specification and a second mapping, a second front-end interface specification, the second mapping indicating a relationship between the general interface specification and the second front-end interface specification, and the first front-end interface specification being different from the second front-end interface specification; Furthermore, the method further includes converting, based on the second front-end interface specification, a second front-end request into a second back-end request associated with the back-end interface.

It should be understood that the content described in the Summary of the Invention part is neither intended to limit key or essential features of the embodiments of the present disclosure, nor intended to limit the scope of the present disclosure. Other features of the present disclosure will become readily understood from the following description.

### DESCRIPTION OF DRAWINGS

The above and other features, advantages, and aspects of the embodiments of the present disclosure will become more apparent with reference to the accompanying drawings and the following detailed description. In the accompanying drawings, identical or similar reference numerals represent identical or similar elements, in which

FIG. 1 illustrates a schematic diagram of an example environment in which a plurality of embodiments of the present disclosure can be implemented;

FIG. 2 illustrates a flow chart of a method for providing an interface according to some embodiments of the present disclosure;

FIG. 3 illustrates a schematic diagram of an example of a mapping description document according to some embodiments of the present disclosure;

FIG. 4 illustrates a schematic diagram of an example process of generating a front-end interface specification for a front-end interface according to some embodiments of the present disclosure;

FIGS. 5A to 5C illustrate schematic diagrams of an example general interface specification, an example mapping description document, and an example mapping function configuration document for generating a new front-end interface specification utilizing a mapping description document and based on a general interface specification according to some embodiments of the present disclosure; and

FIG. 6 illustrates a schematic diagram of an example process of responding to a request from a client utilizing a generated interface specification document for a front-end interface and a mapping function configuration document according to some embodiments of the present disclosure; and

FIG. 7 illustrates a block diagram of a device that can implement a plurality of embodiments of the present disclosure.

### DETAILED DESCRIPTION

The embodiments of the present disclosure will be described below in further detail with reference to the accompanying drawings. Although the accompanying drawings show some embodiments of the present disclosure, it should be understood that the present disclosure may be implemented in various forms, and should not be explained as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the scope of protection of the present disclosure.

In the description of the embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit implementations may also be included below.

Application Programming interface (API) (also referred to as interface herein) is a programming interface used to enable a client of an application to communicate with an application server. Typically, the application provides only one API interface for use by all clients. However, in some cases, multiple API interfaces need to be provided for multiple types of clients for the same application. For example, in some cases, the application needs to expose multiple different API interfaces for internal and external clients. In some cases, there are multiple different versions of API interfaces for the same application for achieving backward compatibility. In some cases, different API interfaces are required for different types of clients (e.g., mobile and desktop clients).

In some conventional solutions, a separate API interface is required for a front-end client in order to meet specific needs of that client. For example, the back end may provide a first back-end service and a second back-end service. For the first back-end service, a back-end developer may develop a first API interface for a first client and develop a second API interface for a second client. For the second back-end service, the back-end developer may develop a third API interface for the first client and a fourth API interface for the second client. In addition, when two clients have different customization requirements for the same back-end service, two different API interfaces are required for the same function, and then the back-end developer needs to develop additional functions to handle the different API interfaces. This approach takes a lot of effort to implement multiple API interfaces in each back-end service, while there may also be a duplicate code logic in the back-end service, making code maintenance difficult. In addition to this, a code specific to a particular client may be added to a business logic code, and consequently the code logic will become more and more complex over time, thereby causing logic errors potentially.

To this end, the embodiments of the present disclosure propose a solution for providing an interface, in which a pre-determined general interface specification may be acquired, the general interface specification being associated with an API interface actually provided by the back end. Then, in this solution, a mapping description document for a first client may be acquired, the mapping description document describing a conversion relationship between the general interface specification and a first front-end interface specification for the first client. Then, in this solution, the first front-end interface specification may be generated based on the mapping description document for the first client and the general interface specification. In this solution, upon receiving a request from the first client that conforms to the first front-end interface specification, the request may be converted, based on the first front-end interface specification, into a back-end request that conforms to a back-end interface and may be processed by a back-end server. In addition, in this solution, a mapping description document for a second client may be acquired, the mapping description document describing a conversion relationship between the general interface specification and a second front-end interface specification for the second client. Then, in this solution, the second front-end interface specification may be generated based on the mapping description document for the second client and the general interface specification. In this solution, upon receiving a request from the second client that conforms to the second front-end interface specification, the request may be converted, based on the second front-end interface specification, into a back-end request that conforms to the same back-end interface and may be processed by the back-end server. In this way, an interface developer does not need to develop two interfaces for the first client and the second client having different requirements, but only needs to provide mapping description documents that satisfy specific requirements, so that different front-end interface specifications corresponding to various types of clients may be automatically generated, thus providing different front-end interfaces for the clients having different requirements based on the same back-end interface. In this way, the workload for interface development can be minimized, the general interface specification and the mapping description documents can also be reused easily, and interface maintenance is simplified, thereby reducing labor and time costs.

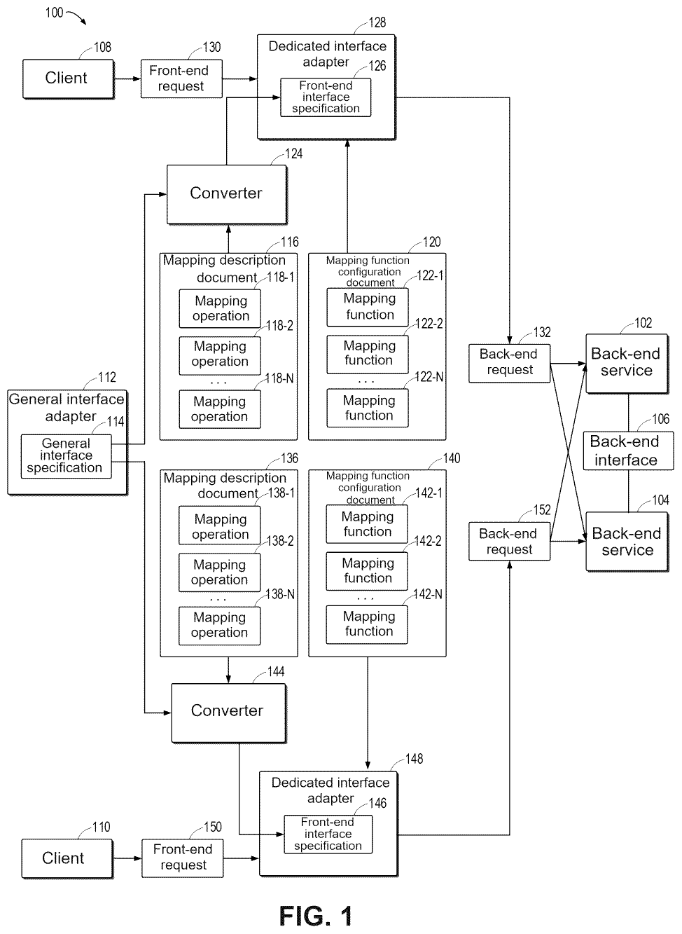

FIG. 1 illustrates a schematic diagram of an example environment 100 in which a plurality of embodiments of the present disclosure can be implemented. As shown in FIG. 1, the environment 100 includes back-end services 102 and 104, and a back-end interface 106 is provided for requesting the back-end services 102 and 104. The environment 100 further includes clients 108 and 110 that may interact with the back-end services 102 and 104 to perform various functions. In the environment 100, different interfaces need to be provided for the clients 108 and 110. For example, the clients 108 and 110 may belong to different types of clients, and a server provides different subsets of back-end interfaces 106 based on the types of the clients, or for the same back-end service 102 or 104, the server needs to provide response results in different formats for the clients 108 and 110.

As shown in FIG. 1, the environment 100 includes a general interface adapter 112. The general interface adapter 112 may implement general functions associated with calling an API and may provide a general interface specification 114. The general interface specification 114 is associated with the back-end interface 106. For example, the general interface specification 114 may provide a definition of the back-end interface 106, which may include information such as endpoints of the back-end interface 106, declarations of elements and properties, definitions of data types, request formats, response formats, parameters, and the like. In the embodiments herein, a representational state transfer (REST) API and an open application programming interface (OpenAPI) specification corresponding thereto are used as examples, but the solution provided by the embodiments herein may also be used for other API interfaces and other specifications. The environment 100 further includes a mapping description document 116 for the client 108, and the mapping description document 116 may describe a conversion relationship between the general interface specification 114 and a front-end interface specification 126 for the client 108. As shown in FIG. 1, the mapping description document 116 includes mapping operations 118-1, 118-2, . . . , and 118-N (collectively referred to herein as mapping operations 118), and mapping operations of the mapping operations 118 are sequential. The environment 100 further includes a mapping function configuration document 120 for the client 108, mapping functions 122-1, 122-2, . . . , and 122-N (collectively referred to herein as mapping functions 122) may be implemented in the mapping function configuration document 120, and the mapping functions 122 may be referenced in the mapping operations 118 of the mapping description document 116 to implement various mapping functions. The environment 100 further includes a converter 124. The converter 124 may utilize the mapping description document 116 to convert the general interface specification 114 into the front-end interface specification 126 for the client 108.

As shown in FIG. 1, the client 108 may initiate a front-end request 130 by calling a front-end interface defined by the front-end interface specification 126. The environment 100 includes a dedicated interface adapter 128 for the client 108, and the dedicated interface adapter 128 may utilize the front-end interface specification 126 and the mapping function configuration document 120 to convert the front-end request 130 into a back-end request 132 that calls the back-end interface 106, and the back-end request 132 may request the back-end service 102 or 104. In this way, the back-end server may provide response information corresponding to the back-end service 102 or 104 based on the received back-end request 132.

As shown in FIG. 1, the environment 100 further includes a mapping description document 136 for the client 110, and the mapping description document 136 may describe a conversion relationship between the general interface specification 114 and the front-end interface specification 146 for the client 110. As shown in FIG. 1, the mapping description document 136 includes mapping operations 138-1, 138-2, . . . , and 138-N (collectively referred to herein as mapping operations 138), and mapping operations of the mapping operations 138 are sequential. The environment 100 further includes a mapping function configuration document 140 for the client 110, mapping functions 142-1, 142-2, . . . , and 142-N (collectively referred to herein as mapping functions 142) may be implemented in the mapping function configuration document 140, and the mapping functions 142 may be referenced in the mapping operations 138 of the mapping description document 136 to implement various mapping functions. The environment 100 further includes a converter 144. The converter 144 may utilize the mapping description document 116 to convert the general interface specification 114 into the front-end interface specification 146 for the client 110.

As shown in FIG. 1, the client 110 may initiate a front-end request 150 by calling a front-end interface defined by the front-end interface specification 146. The environment 100 includes a dedicated interface adapter 148 for the client 110, and the dedicated interface adapter 148 may utilize the front-end interface specification 146 and the mapping function configuration document 140 to convert the front-end request 150 into a back-end request 152 that calls the back-end interface 106, and the back-end request 152 may request the back-end service 102 or 104. In this way, the back-end server may provide response information corresponding to the back-end service 102 or 104 based on the received back-end request 152.

It should be noted that in the environment 100 shown in FIG. 1, the converters 124 and 144 are shown as two separate components, but they may also be implemented as the same component. It should also be noted that mapping function configuration documents 120 and 140 are optional, and when the conversion of the general interface specification 114 to the front-end interface specification 126 is not very complex, the mapping operations 118 in the mapping description document 116 may not reference the mapping functions 122 that may perform complex operations, and accordingly, the mapping function configuration document 120 may be omitted. Similarly, when the conversion of the general interface specification 114 to the front-end interface specification 146 is not very complex, the mapping function configuration document 140 may also be omitted.

In this manner, a client-specific front-end interface specification may be generated by developing only one back-end interface 106 and providing multiple mapping description documents (and, optionally, providing corresponding multiple mapping function configuration documents) for multiple clients, so that a specific front-end interface can be provided to the client to fulfill the specific requirements of the client. This approach can reduce time and labor costs in interface development, reduce the complexity of interface implementation, and improve the maintainability of interfaces. In addition, the mapping description documents and the mapping function configuration documents are reused for multiple clients of the same type, and the front-end interface specification specific to each client is generated, so that time and labor costs can be further reduced.

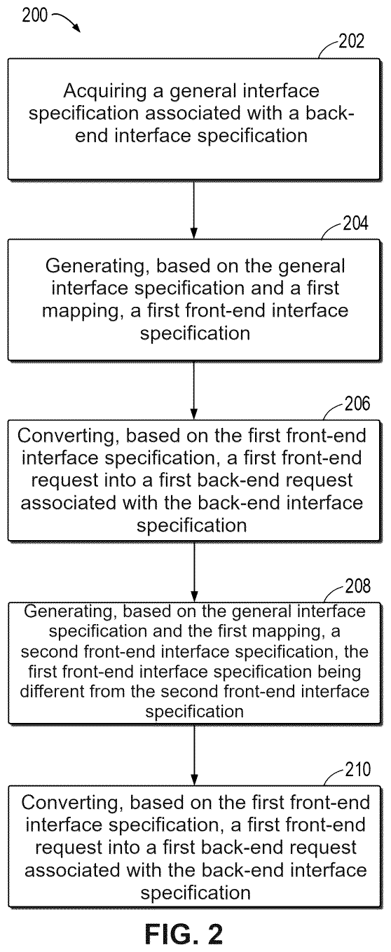

FIG. 2 illustrates a flow chart of a method 200 for providing an interface according to some embodiments of the present disclosure. As shown in FIG. 2, at a block 202, the method 200 may acquire a general interface specification associated with a back-end interface. For example, in the environment 100 shown in FIG. 1, the general interface specification 114 associated with the back-end interface 106 may be acquired. For example, a definition of the back-end interface 106 may be provided in the general interface specification 114, which may include information such as endpoints of the back-end interface 106, declarations of elements and properties, definitions of data types, request formats, response formats, parameters, and the like.

At a block 204, the method 200 may generate, based on the general interface specification and a first mapping, a first front-end interface specification, the first mapping indicating a conversion relationship between the general interface specification and the first front-end interface specification. For example, in the environment 100 as shown in FIG. 1, the converter 124 may generate the front-end interface specification 126 for the client 108 based on the general interface specification 114 and the mapping description document 116. For example, the converter 124 may sequentially apply one or more mapping operations 118 specified in the mapping description document 116 to the general interface specification 114, so that the front-end interface specification 126 for the client 108 may be generated.

At a block 206, the method 200 may convert, based on the first front-end interface specification, a first front-end request into a first back-end request associated with the back-end interface. For example, in the environment 100 shown in FIG. 1, the dedicated interface adapter 128 receives the front-end request 130 from the client 108, and the interface called by the front-end request 130 is a front-end interface that is specific to the client 108 and conforms to the definition in front-end interface specification 126. The dedicated interface adapter 128 may convert the front-end request 130 into the back-end request 132 based on the front-end interface specification 126, and the back-end request 132 calls the back-end interface 106 that may be processed by a back-end server, thereby enabling the back-end server to respond to the back-end request 132 and providing the back-end service 102 or 104 to the client 108.

At a block 208, the method 200 may generate, based on the general interface specification and a second mapping, a second front-end interface specification, the second mapping indicating a relationship between the general interface specification and the second front-end interface specification, and the first front-end interface specification being different from the second front-end interface specification. For example, in the environment 100 shown in FIG. 1, the converter 144 may generate the front-end interface specification 146 for the client 110 based on the general interface specification 114 and the mapping description document 136. For example, the converter 144 may sequentially apply one or more of mapping operations 138 specified in the mapping description document 136 to the general interface specification 114, so that the front-end interface specification 146 for the client 110 may be generated. Because the clients 108 and 110 may have different requirements for back-end services (e.g., for the same back-end service, the clients 108 and 110 send request parameters in different formats or receive response results in different formats, or the client 108 has access to the back-end service 102 but the client 110 does not have access to the back-end service 102) and two different interfaces are required for them, the front-end interface specification 126 and the front-end interface specification 146 may be interface specifications that define different front-end interfaces.

At a block 210, the method 200 may convert, based on the second front-end interface specification, a second front-end request into a second back-end request associated with the back-end interface. For example, in the environment 100 shown in FIG. 1, the dedicated interface adapter 148 receives the front-end request 150 from the client 110, and the interface called by the front-end request 130 is a front-end interface that is specific to the client 110 and conforms to the definition in front-end interface specification 146. The dedicated interface adapter 148 may convert the front-end request 150 into the back-end request 152 based on the front-end interface specification 146, and the back-end request 152 calls the back-end interface 106 that may be processed by a back-end server, thereby enabling the back-end server to respond to the back-end request 152 and providing the back-end service 102 or 104 to the client 110.

In this way, an interface developer does not need to develop two interfaces for the client 108 and the client 110 having different requirements, but only needs to provide the mapping description documents 116 and 136 that satisfy specific requirements, so that the front-end interface specification 126 for the client 108 and the front-end interface specification 146 for the client 110 may be automatically generated, thus providing different front-end interfaces for the clients having different requirements based on the same back-end interface. In this way, the workload for interface development can be minimized, the general interface specification and mapping description documents can also be reused easily, interface maintenance is simplified, and development and maintenance efficiency is provided, thereby reducing labor and time costs.

As described above, the mapping description document includes one or more mapping operations, and in some embodiments, the mapping operation includes a mapping operation indicator indicating a type of the mapping operation and a path specifying a location of a target object to be operated. In some embodiments, the type of the mapping operation includes at least one of the following: adding a new value to a target location, removing a current value from the target object, replacing a current value at a target location with a new value, combining a new value with a current value at a target location and then inserting into the target location, and moving a current value from one location to another location. In some embodiments, the mapping operation includes a reference to a mapping function and parameters of the mapping function.

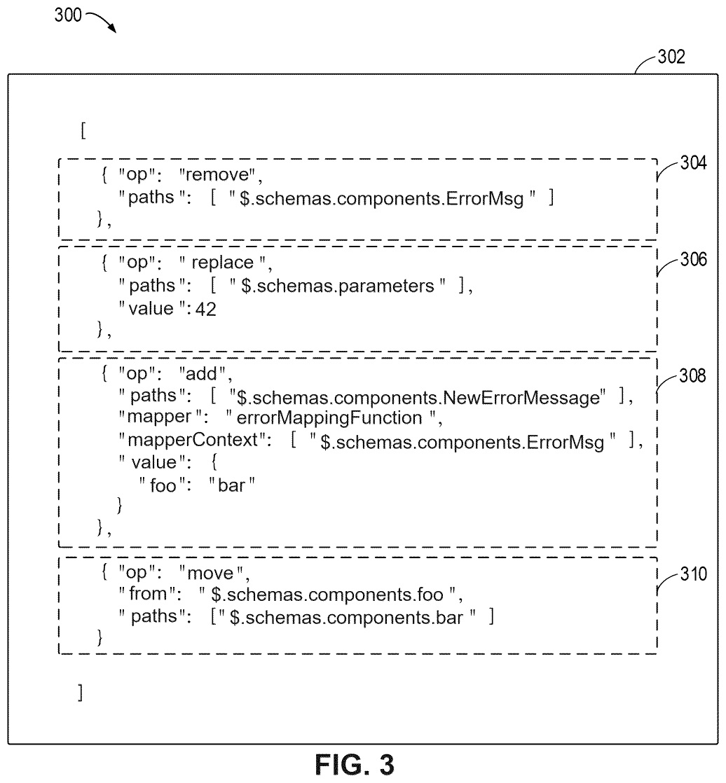

FIG. 3 illustrates a schematic diagram of an example 300 of a mapping description document according to some embodiments of the present disclosure. As shown in FIG. 3, the example 300 includes a mapping description document 302, and the mapping description document 302 includes an array including a plurality of mapping operations stored in sequence, i.e., a remove operation 304, a replace operation 306, an add operation 308, and a move operation 310. The mapping operations are the basic objects of a mapping operation document, and each operation describes an adaptive action to a source interface specification document (e.g., the general interface specification 114 shown in FIG. 1) to form a target interface specification document (e.g., the front-end interface specifications 126 and 146 shown in FIG. 1). Each mapping operation object is composed of several members (as parameters of the mapping operation). Some members are mandatory, while some are optional, as well as some members are only valid for specific types of operations. Table 1 below shows members available in some embodiments:

TABLE 1

| Name of member | Type | Interpretation |
|---|---|---|
| op | enumeration | Indicate types of mapping operations, which may |
| | | be “add,” “remove,” “replace,” “assign,” and |
| | | “move.” |
| paths | array | An array of JSONPath expressions, which will be |
| | | parsed to specify a location of a target object to be |
| | | operated. |
| from | string | Be valid only for the “move” operation. The |
| | | JSONPath expression is used to indicate a source |
| | | location of the move operation. |
| mapper | string | Be optional. Specify the name of a mapping |
| | | function to perform the runtime conversion. |
| mapperContext | array | Be optional, specify an array of input parameters |
| | | for mapping functions. |
| value | object | the object added, assigned, or removed. Not |
| | | available in the “remove” and “move” operations. |

In the example 300, JSONPath may be used to position one or more target locations in a source interface specification. An example of the JSONPath expression is “$.store.book [0].title.”

As shown in Table 1 above, types of mapping operations may include “add,” “remove,” “replace,” “assign,” and “move.” By the “add” operation, a new value may be added to a target location. The target location may be an array or an object, and if an index is specified in the path string, the value object will be inserted at that index. If a current value already exists at the target location, the current value will be replaced with a new value. In some embodiments, the mapping function for the “add” operation may accept multiple inputs. By the “remove” operation, a value may be removed from the target object. If the specified path fails to parse any valid objects, the “remove” operation fails. If the target object to be parsed is an element of an array, all elements after the removed element will be moved forward. By the “replace” operation, the current value at the target location may be replaced with a given new value. If the target location does not exist, the target location may be added. The “assign” operation is similar to the “replace” operation, but during the “assign” operation, the given new value will be combined with the current value at the target location before inserted into the target position (often used in scenarios where only minor changes to the current value are required). By the “move” operation, a value may be moved from one location to another location. If the source location does not exist, the “move” operation fails.

As shown in FIG. 3, the mapping functions may be used in the mapping operations (e.g., by adding members of mapper and mapperContext in the “add” operation 308). A mapping function is used to map a request from a client (front-end interface) to a server (back-end interface) during running and to map a response from the server to the client. The mapping function may be defined in a separate file using any programming language. The member mapper of the mapping operation may accept one or more inputs, and the inputs are defined by the member mapperContext of an operation object.

In this way, a conversion relationship between an original interface specification (i.e., the back-end interface specification or general interface specification) and a target interface specification (i.e., the front-end interface specification) may be described using pre-determined rules and a small amount of codes, so that the time and labor costs consumed by the development of new interfaces can be reduced. In addition, the mapping description document may be reused to generate similar front-end interface specifications for other clients, thereby further reducing time and labor costs.

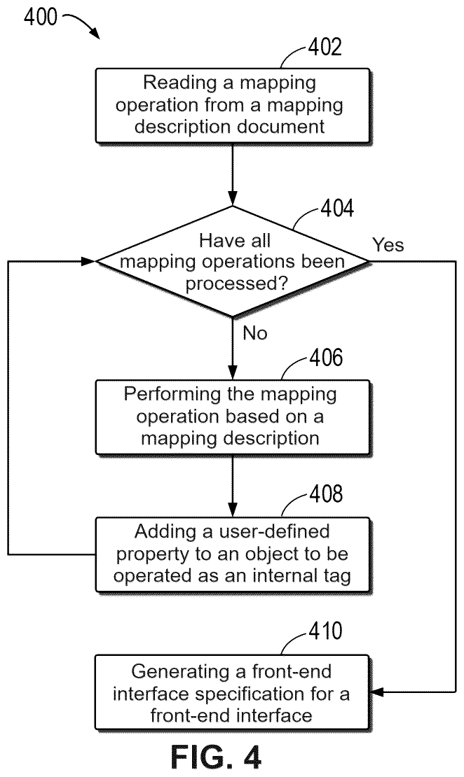

In some embodiments, during generation of the front-end interface specification, an object in the general interface specification may be updated based on the mapping operations in the mapping description document, and then a tag may be added to the updated object, the tag indicating a mapping between the updated object and the object before the update. FIG. 4 illustrates a schematic diagram of an example process 400 of generating a front-end interface specification for a front-end interface according to some embodiments of the present disclosure. As shown in FIG. 4, at a block 402, the process 400 may read mapping operations from a mapping description document. For example, in the environment 100 shown in FIG. 1, the converter 124 may read the mapping operations 118 from the mapping description document 116. At a block 404, the process 400 may determine whether all the mapping operations have been processed. For example, in the environment 100 shown in FIG. 1, the converter 124 may determine whether all of the mapping operations 118-1 to 118-N in the mapping description document 116 have been processed. If there are still unprocessed mapping operations among the mapping operations 118-1 to 118-N, the process 400 proceeds to a block 406.

At the block 406, the process 400 may perform mapping operations based on mapping descriptions of the mapping operations. For example, in the environment 100 shown in FIG. 1, the converter 124 may perform mapping operations based on descriptions of the mapping operations 118 in the mapping description document 116. The mapping description document 116 may be, for example, the mapping description document 302 shown in FIG. 3, and the mapping operation 118-1 may be, for example, the remove operation 304 shown in FIG. 3. The converter 124 may perform the mapping operations based on the value of each member defined in, for example, the remove operation 304.

At a block 408, the process 400 may add a user-defined property as an internal tag to an object to be operated. Since the object in the front-end interface specification has been updated, there is a need to maintain a mapping between the updated object in the front-end interface specification and the original object in the general interface specification. Therefore, the process 400 may add a user-defined property to the object to be operated after the mapping operation is performed on the original object in the general interface specification, where the user-defined property may indicate the mapping between the updated object and the original object. Then, the process 400 returns to the block 404 in which whether all mapping operations have been processed is redetermined. If all mapping operations have been processed, the process 400 proceeds to a block 410. At the block 410, the process 400 may generate a front-end interface specification for a front-end interface. For example, in the environment 100 shown in FIG. 1, after all mapping operations 118 have been sequentially processed, the converter 124 may generate the front-end interface specification 126 for the client 108.

In this manner, it is possible to generate a new front-end interface specification based on the general interface specification and the mapping description document, thereby providing a front-end interface specific to a client and meeting the client's specific requirements for the interface.

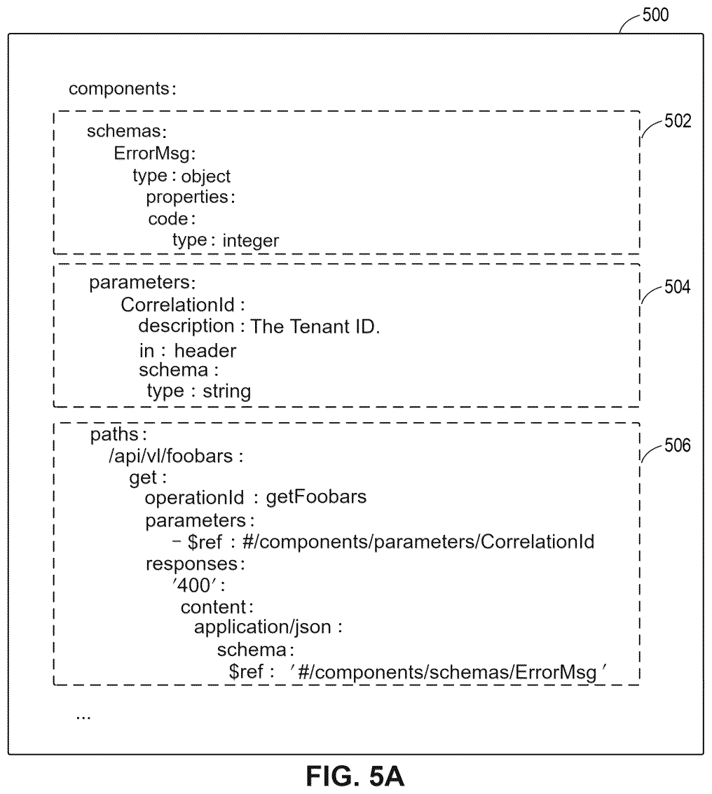

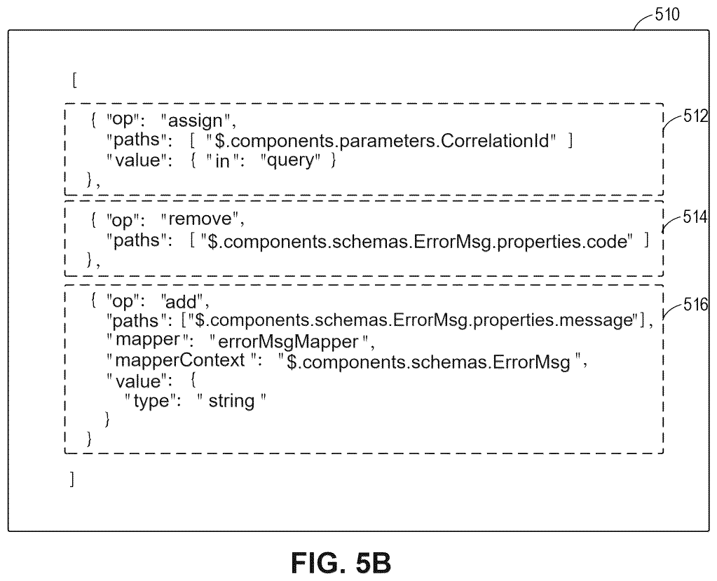

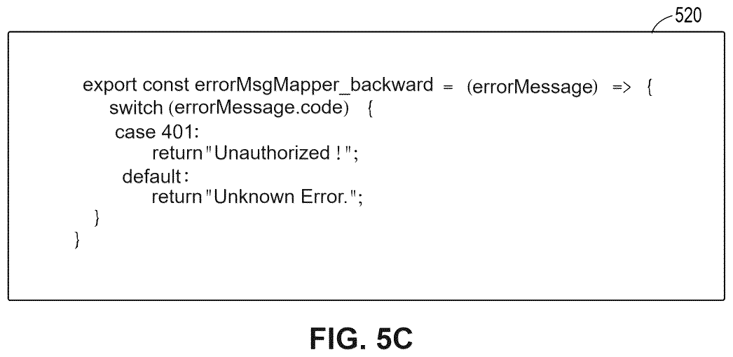

FIGS. 5A to 5C illustrate schematic diagrams of an example general interface specification 500, an example mapping description document 510, and an example mapping function configuration document 520 for generating a new front-end interface specification utilizing a mapping description document and based on a general interface specification according to some embodiments of the present disclosure. In the example shown in FIGS. 5A to 5C, a current product already provides a back-end interface that is defined by a general interface specification 500. Then, it is necessary to provide a new front-end interface for a new type of clients of that product. In the back-end interface, on the one hand, an integer error code is used as an error message and on the other hand, parameter “CorrelationID” is placed in the header of a request. The requirement of the new type of clients refers to using a human-readable statement as an error message and placing the “CorrelationID” parameter in query parameters of the request.

FIG. 5A illustrates the example general interface specification 500 for defining a back-end interface according to embodiments of the present disclosure. As shown in FIG. 5A, the general interface specification 500 defines schema (i.e., “schemas”) in a block 502, and the schema include a data structure “ErrorMsg,” “ErrorMsg” is of the type “object” (i.e., “object”) and has a property such as “code” (i.e., “code”), which is of the type “integer” (i.e., “integer”). Parameters are defined in a block 504, including parameter “CorrelationId,” which represents a tenant identifier and is passed in the “header” (i.e., “header”) of the request, and the schema type of the parameter is “string” (i.e., “string”). The endpoint “/api/v1/foobars” is defined in a block 506, which includes a GET method. Parameters of the GET method refer to the parameter “CorrelationID” in the block 504, and its responses include a code “400” while its schema refers to the schema “ErrorMsg” in the block 502.

FIG. 5B illustrates the example mapping description document 510 for converting the general interface specification 500 into a new front-end interface specification according to embodiments of the present disclosure. As shown in FIG. 5B, the mapping description document 510 contains an array that sequentially stores an “assign” operation 512, a “remove” operation 514, and an “add” operation 516. First, the location of parameter “CorrelationID” passed in the request is changed from “header” to “query.” In the “assign” operation 512, member “op” specifies that the operation type is “assign.” Member “paths” specifies the location of a target object to be updated by the “assign” operation 512 (i.e., the parameter “CorrelationID” under “parameters” under “component” in the general interface specification 500). Member “value” specifies the location of an incoming parameter (i.e., “in”) as “query” (i.e., “query”). Thus, the “assign” operation 512 plays a role in assigning the new value “query” to the location of the incoming parameter of the parameter “CorrelationID.”

Then, in order to change the returned error message from the error code to a human-readable statement, the property of the schema “ErrorMsg” may be changed from “code” to “string,” and the corresponding string is returned based on the value of the code using the mapping function. As shown in FIG. 5B, the “assign” operation 512 is followed by the “remove” operation 514. In the “remove” operation 514, the member “op” specifies the operation type is “remove,” and the member “paths” specifies the location of a target object to be updated by the “remove” operation 514 (i.e., the property “code” under “properties” under “ErrorMsg” under “schemas” under “component” in the general interface specification 500). Thus, the “remove” operation 514 has an effect of removing the property “code” of the schema “ErrorMsg.”

As shown in FIG. 5B, the “remove” operation 514 is followed by the “add” operation 516. In the “add” operation, the member “op” specifies that the operation type is “add,” and the member “paths” specifies the location to which the “add” operation 516 will add content (i.e., the property “message” under “properties” under “ErrorMsg” under “schemas” under “components”). The member “mapper” specifies the name (i.e., “errorMsgMapper”) of the referenced mapping function. The member “mapperContext” specifies the schema (i.e., “ErrorMsg”) of the parameter to be passed to the mapping function. The member “value” specifies a value (i.e., of type “string”) to be added to the property “message.” Thus, the “add” operation 516 has an effect of adding the property “message” to the schema “ErrorMsg,” the property “message” is of the type of “string,” and the mapping function “errorMsgMapper” implements the conversion between the schema “ErrorMsg” of the general interface specification 500 and the schema “ErrorMsg” of the new front-end interface specification.

FIG. 5C illustrates the example mapping function configuration document 520 according to some embodiments of the present disclosure. As shown in FIG. 5, an implementation of the mapping function “errorMsgMapper” is defined in the mapping function configuration document 520. In this implementation, if the code of the error message returned by the back-end interface is “401,” the new front-end interface returns a converted string “Unauthorized!” (“Unauthorized!”); otherwise, regardless of the code of the error message returned by the back-end interface, the new front-end interface returns the string “Unknown Error.” (“Unknown Error.”).

In this way, the new front-end interface specification may be generated based on the general interface specification 500 and the mapping description document 510, and the mapping function configuration document 520 may be utilized to implement a complex conversion logic between the back-end interface and the front-end interface in the front-end interface specification, thereby satisfying various requirements from different clients and improving user satisfaction.

In some embodiments, when converting a front-end request into a back-end request that calls a back-end interface, the front-end request may be verified based on the front-end interface specification. In some embodiments, the back-end request may be sent to a server, and then back-end response information associated with the general interface specification may be received from the server. In some embodiments, the back-end response may be converted into a front-end response associated with the front-end interface specification based on the front-end interface specification and the mapping function configuration document. In some embodiments, the front-end response may be verified based on the first front-end interface specification, and then the front-end response may be utilized to respond to the front-end request.

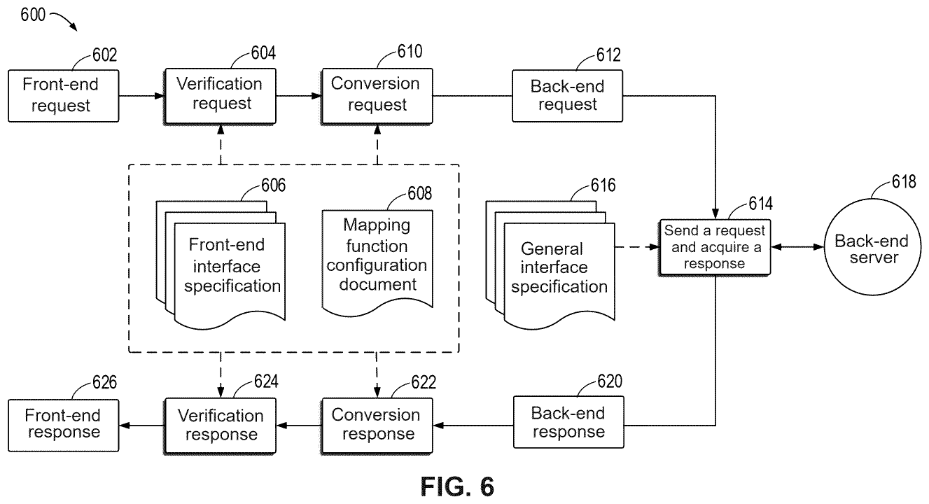

FIG. 6 illustrates a schematic diagram of an example process 600 of responding to a request from a client utilizing a generated interface specification document for a front-end interface and a mapping function configuration document according to some embodiments of the present disclosure. As shown in FIG. 6, at a block 604, the process 600 may utilize a front-end interface specification 606 (e.g., the front-end interface specification 126 in FIG. 1) to verify a front-end request 602 (e.g., the front-end request 130 from the client 108 in FIG. 1) from a client. For example, the process 600 may verify whether a format of the front-end request 602 conforms to a request format defined in the front-end interface specification 606. Then, at a block 610, the process 600 may utilize the front-end interface specification 606 and a mapping function configuration document 608 to convert the verified front-end request 602 into a back-end request 612. At a block 614, the process 600 may send the back-end request 612 to a back-end server 618 and acquire a back-end response 620 from the back-end server 618, with both the back-end request 612 and the back-end response 620 conforming to a definition of the back-end interface in the general interface specification 616. At a block 622, the process 600 may convert the back-end response 620 into a front-end response 626 based on the front-end interface specification 606 and the mapping function configuration document 608. Before returning the front-end response 626 to the client, at a block 624, the process 600 may utilize the front-end interface specification 606 to verify the front-end response 626. For example, the process 600 may verify whether a format of the front-end response 626 conforms to a response format defined in the front-end interface specification 606.

In this manner, the format of the request from the client and the format of the response returned to the client may be verified, so that the system stability can be improved. In addition, the conversion between the front-end request and the back-end request can also be realized, so that the back-end server can provide corresponding responses. In addition, the conversion between the back-end response and the front-end response can also be realized, so that the client can obtain a response that satisfies its requirements, thereby improving customer satisfaction.

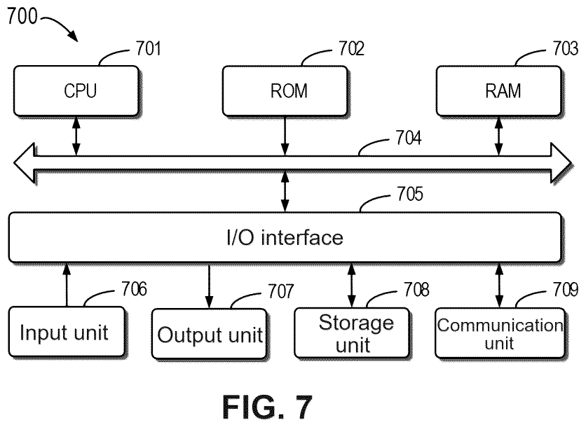

FIG. 7 illustrates a schematic block diagram of an example device 700 which can be used to implement embodiments of the present disclosure. For example, the server providing the back-end services 102 and 104 shown in FIG. 1 may be the example device 700 as shown in FIG. 7. As shown in the figure, the device 700 includes a computing unit 701 that may perform various appropriate actions and processing according to computer program instructions stored in a read-only memory (ROM) 702 or computer program instructions loaded from a storage unit 708 to a random access memory (RAM) 703. Various programs and data required for the operation of the device 700 may also be stored in the RAM 703. The computing unit 701, the ROM 702, and the RAM 703 are connected to each other via a bus 704. An Input/Output (I/O) interface 705 is also connected to the bus 704.

A plurality of components in the device 700 are connected to the I/O interface 705, including: an input unit 706, such as a keyboard and a mouse; an output unit 707, such as various types of displays and speakers; a storage unit 708, such as a magnetic disk and an optical disc; and a communication unit 709, such as a network card, a modem, and a wireless communication transceiver. The communication unit 709 allows the device 700 to exchange information/data with other devices via a computer network, such as the Internet, and/or various telecommunication networks.

The computing unit 701 may be various general-purpose and/or special-purpose processing components with processing and computing capabilities. Some examples of the computing unit 701 include, but are not limited to, central processing units (CPUs), graphics processing units (GPUs), various specialized artificial intelligence (AI) computing chips, various computing units for running machine learning model algorithms, digital signal processors (DSPs), and any appropriate processors, controllers, microcontrollers, etc. The computing unit 701 performs various methods and processes described above, such as the method 200. For example, in some embodiments, the method 200 may be implemented as a computer software program that is tangibly included in a machine-readable medium, such as the storage unit 708. In some embodiments, part or all of the computer program may be loaded and/or installed onto the device 700 via the ROM 702 and/or the communication unit 709. When the computer program is loaded to the RAM 703 and executed by the computing unit 701, one or more steps of the method 200 described above may be performed. Alternatively, in other embodiments, the computing unit 701 may be configured to implement the method 200 in any other suitable manners (such as by means of firmware).

The functions described hereinabove may be performed at least in part by one or more hardware logic components. For example, without limitation, example types of available hardware logic components include: a Field Programmable Gate Array (FPGA), an Application Specific Integrated Circuit (ASIC), an Application Specific Standard Product (ASSP), a System on Chip (SOC), a Load Programmable Logic Device (CPLD), and the like.

Program code for implementing the method of the present disclosure may be written by using one programming language or any combination of a plurality of programming languages. The program code may be provided to a processor or controller of a general purpose computer, a special purpose computer, or another programmable data processing apparatus, such that the program code, when executed by the processor or controller, implements the functions/operations specified in the flow charts and/or block diagrams. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combinations thereof. Additionally, although operations are depicted in a particular order, this should be understood that such operations are required to be performed in the particular order shown or in a sequential order, or that all illustrated operations should be performed to achieve desirable results. Under certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. Conversely, various features that are described in the context of a single implementation may also be implemented in a plurality of implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

1. A method for providing an interface, comprising:
acquiring a general interface specification associated with a back-end interface;
generating, based on the general interface specification and a first mapping, a first front-end interface specification, the first mapping indicating a conversion relationship between the general interface specification and the first front-end interface specification;
converting, based on the first front-end interface specification, a first front-end request into a first back-end request associated with the back-end interface;
generating, based on the general interface specification and a second mapping, a second front-end interface specification, the second mapping indicating a relationship between the general interface specification and the second front-end interface specification, and the first front-end interface specification being different from the second front-end interface specification; and
converting, based on the second front-end interface specification, a second front-end request into a second back-end request associated with the back-end interface.

2. The method according to claim 1, wherein generating, based on the general interface specification and the first mapping, the first front-end interface specification comprises:
updating, based on a mapping operation in the first mapping, an object in the general interface specification; and
adding a tag to the updated object, the tag indicating a mapping between the updated object and the object before updating the object in the general interface specification.

3. The method according to claim 1, wherein a mapping operation in the first mapping and the second mapping comprises: a mapping operation indicator indicating a type of the mapping operation and a path specifying a location of a target object to be operated.

4. The method according to claim 3, wherein the type of the mapping operation comprises at least one of the following:
adding a new value to a target location, removing a current value from the target object, replacing a current value at a target location with a new value, combining a new value with a current value at a target location and then inserting into the target location, or moving a current value from one location to another location.

5. The method according to claim 4, wherein the mapping operation in the first mapping comprises a reference to a mapping function and parameters of the mapping function, and the method further comprises:
acquiring a mapping function configuration document that implements the mapping function; and
converting, based on the first front-end interface specification and the mapping function configuration document, the first front-end request into the first back-end request associated with the back-end interface.

6. The method according to claim 5, wherein converting, based on the first front-end interface specification and the mapping function configuration document, the first front-end request into the first back-end request associated with the back-end interface comprises:
verifying the first front-end request based on the first front-end interface specification.

7. The method according to claim 6, wherein the method further comprises:
sending the first back-end request to a server; and
receiving, from the server, back-end response information associated with the general interface specification.

8. The method according to claim 7, wherein the method further comprises:
converting, based on the first front-end interface specification and the mapping function configuration document, the back-end response into a front-end response associated with the first front-end interface specification.

9. The method according to claim 8, wherein the method further comprises:
verifying the front-end response based on the first front-end interface specification; and
utilizing the front-end response to respond to the first front-end request.

10. An electronic device, comprising:
at least one processor; and
a memory, coupled to the at least one processor and having instructions stored thereon, wherein the instructions, when executed by the at least one processor, cause the electronic device to perform actions, the actions comprising:
acquiring a general interface specification associated with a back-end interface;
generating, based on the general interface specification and a first mapping, a first front-end interface specification, the first mapping indicating a conversion relationship between the general interface specification and the first front-end interface specification;
converting, based on the first front-end interface specification, a first front-end request into a first back-end request associated with the back-end interface;
generating, based on the general interface specification and a second mapping, a second front-end interface specification, the second mapping indicating a relationship between the general interface specification and the second front-end interface specification, and the first front-end interface specification being different from the second front-end interface specification; and
converting, based on the second front-end interface specification, a second front-end request into a second back-end request associated with the back-end interface.

11. The device according to claim 10, wherein generating, based on the general interface specification and the first mapping, the first front-end interface specification comprises:
updating, based on a mapping operation in the first mapping, an object in the general interface specification; and
adding a tag to the updated object, the tag indicating a mapping between the updated object and the object before updating the object in the general interface specification.

12. The device according to claim 10, wherein a mapping operation in the first mapping and the second mapping comprises: a mapping operation indicator indicating a type of the mapping operation and a path specifying a location of a target object to be operated.

13. The device according to claim 12, wherein the type of the mapping operation comprises at least one of the following:
adding a new value to a target location, removing a current value from the target object, replacing a current value at a target location with a new value, combining a new value with a current value at a target location and then inserting into the target location, or moving a current value from one location to another location.

14. The device according to claim 13, wherein the mapping operation in the first mapping comprises a reference to a mapping function and parameters of the mapping function, and the actions further comprise:
acquiring a mapping function configuration document that implements the mapping function; and
converting, based on the first front-end interface specification and the mapping function configuration document, the first front-end request into the first back-end request associated with the back-end interface.

15. The device according to claim 14, wherein converting, based on the first front-end interface specification and the mapping function configuration document, the first front-end request into the first back-end request associated with the back-end interface comprises:
verifying the first front-end request based on the first front-end interface specification.

16. The device according to claim 15, wherein the actions further comprise:
sending the first back-end request to a server; and
receiving, from the server, back-end response information associated with the general interface specification.

17. The device according to claim 16, wherein the actions further comprise:
converting, based on the first front-end interface specification and the mapping function configuration document, the back-end response into a front-end response associated with the first front-end interface specification.

18. The device according to claim 17, wherein the actions further comprise:
verifying the front-end response based on the first front-end interface specification; and
utilizing the front-end response to respond to the first front-end request.

19. A computer program product tangibly stored on a non-volatile computer-readable medium and comprising machine-executable instructions, which when executed by a processor, cause the processor to perform operations, the operations comprising:
acquiring a general interface specification associated with a back-end interface;
generating, based on the general interface specification and a first mapping, a first front-end interface specification, the first mapping indicating a conversion relationship between the general interface specification and the first front-end interface specification;
converting, based on the first front-end interface specification, a first front-end request into a first back-end request associated with the back-end interface;
generating, based on the general interface specification and a second mapping, a second front-end interface specification, the second mapping indicating a relationship between the general interface specification and the second front-end interface specification, and the first front-end interface specification being different from the second front-end interface specification; and
converting, based on the second front-end interface specification, a second front-end request into a second back-end request associated with the back-end interface.

20. The computer program product according to claim 19, wherein generating, based on the general interface specification and the first mapping, the first front-end interface specification comprises:
updating, based on a mapping operation in the first mapping, an object in the general interface specification; and
adding a tag to the updated object, the tag indicating a mapping between the updated object and the object before the update.
